(19) United States
(12) Patent Application Publication
(10) Pub. No.: US 2007/0020036 A1
(43) Pub. Date: Jan. 25, 2007

(54) Novelty caps for writing instruments

(76) Inventor: Steven James Perrin, Greater London (GB)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 10/557,760

(22) PCT Filed: May 19, 2004
(86) PCT No.: PCT/GB04/02168

§ 371 Date: Nov. 18, 2005

(30) Foreign Application Priority Data
May 20, 2003 (GB) 0311559.9

(51) Int. Cl. B43K 23/12; B43K 29/00

(52) U.S. Cl. 401/247; 401/195

(57) ABSTRACT

A top for a writing instrument comprises a body of transparent material, an insert encapsulated within the body, and at least one display face defined by portions of the insert for displaying an image through the body to the exterior. The transparent material is advantageously a clear silicone rubber.

### FIELD OF THE INVENTION

The present invention relates to caps for writing instruments or simply for positioning on the end of sticks to be used by children in play, said caps having amusement or play value, and to writing instruments or sticks equipped with such caps.

### BACKGROUND TO THE INVENTION

U.S. Pat. No. 4,509,875 discloses a felt pen having a bar-shaped main body and transparent caps for writing tips at opposed ends of the main body, the pen caps being arranged so that the pen can stand at either end.

U.S. Pat. No. 6,149,333 discloses a ball-point pen or other writing instrument having a shaft about 10 mm in diameter and about 130 cm long which engages balls of rubbery elastic material at each end and of diameter about 35 mm, being hopefully large enough to minimise the risk of a ball being inadvertently swallowed by an infant, and one of the balls acting as the cap of the pen. When the pen is dropped or thrown, the balls cause the pen to bounce in an allegedly entertaining fashion. The balls are typically of a bright colour such as orange or red and may be made of a conventional rubber or of a silicone rubber. Alternatives to a spherical shape include polyhedral shapes with indented surfaces like the indentations of a golf-ball. The writing mechanism may be that of a ball-point pen, a pen with a fibre-tip nib or a conventional fountain pen mechanism.

### SUMMARY OF THE INVENTION

Am object of the invention is to provide a novelty top or cap structure for a pen or other writing instrument that has additional amusement or play value.

In one aspect the invention provides a top or cap for a writing instrument comprising a body of clear or transparent material, an insert encapsulated within the body, and at least one display face defined by portions of the insert for displaying an image through the body to the exterior.

The invention also relates to a writing instrument having a shaft provided at one or both ends with a top or cap as aforesaid.

It is considered that a pen with a ball at one end can be dropped or thrown and will have amusing bounce characteristics also. Furthermore the cap with the molded-in image-bearing inserts, which are easy to change to present a range of e.g. collectable images, will have amusement value independent of bounce.

### BREIF DESCRIPTION OF THE DRAWINGS

How the invention may be put into effect will now be explained, by way of example only, with reference to the accompanying drawings, in which:

FIG. 1 is an exploded perspective view of a first embodiment of a pen having a removable cap shown in alternative positions;

FIG. 2 is a view of one end of the pen with the cap fitted thereon;

FIG. 3 is a diagrammatic view of one end of the pen with an encapsulatable insert and a pair of adhesive labels; and

FIGS. 4a-4c are a diagrammatic longitudinal section, underneath view and transverse section of the cap;

FIG. 5 is a view of a two-part moldable-in insert for a second embodiment of the pen and cap together with a clip for fitting into the insert after it has been moulded into the transparent rubber;

FIG. 6 is a diagrammatic transverse section of the cap with the moulded-in insert and the clip of FIG. 5; and

FIG. 7 is a diagrammatic longitudinal section of the cap with the moulded-in insert and the clip of FIG. 5 and with part of the pen inserted into the cap.

### DETAILED DESCRIPTION OF PREFERRED EMBODIMENTS

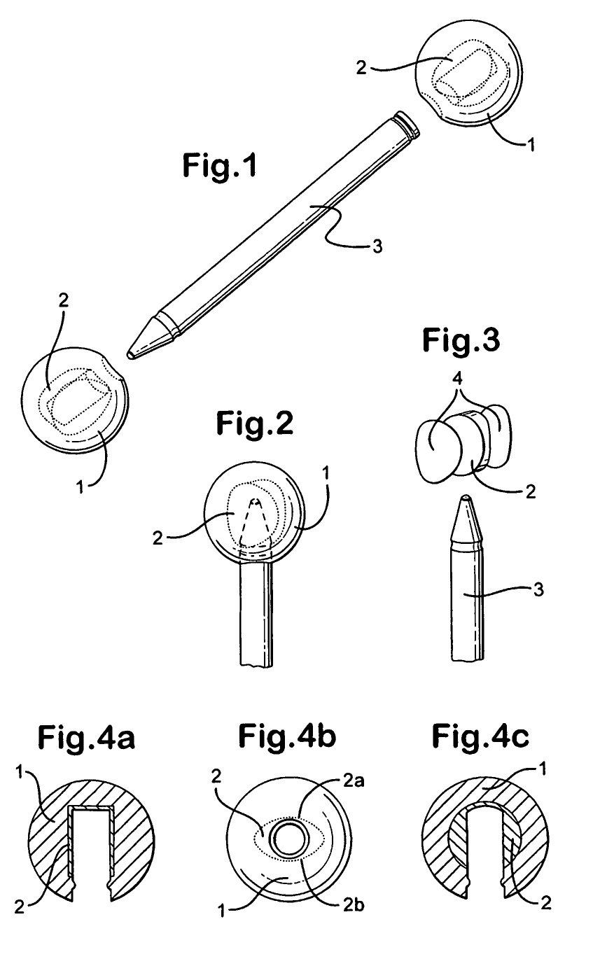

As seen in FIG. 1, a generally ball-shaped pen-top 1 of diameter e.g. about 33 mm formed in a high-bounce grade of transparent silicone rubber has a moulded-in insert 2 and is a snap fit onto an end of a writing instrument such as a ball-point or fibre-tip pen 3. The insert 2 is of a plastics material having a higher melting point than the cure temperature of the silicone rubber and has a pair of oppositely directed faces whose shape is complementary to the shape of the pen-top, in this instance circular. As is apparent from FIG. 4b, when the insert is viewed in end profile the faces 2a, 2b are biconvex. Design-carrying labels 4 are adhered to the opposed faces of the insert 2 before it is encapsulated in the silicone rubber to form the pen-top. Because of its shape the clear rubber of the pen-top acts as a magnifier so that ahthough the image on the labels 4 are smaller than the ball, they appear full-size or nearly so.

Various changes may, of course be made to the described embodiment without departing from the invention.

The body may be formed of any moldable optically clear plastics material if the amusement value of the images is required but bounce characteristics are not, for example nucleated polypropylene, polystyrene, ethylene-α-olefin copolymers, polycarbonates, polysulphone, polyether sulphones, polyethylene terephthalate, glycol-modified polyethylene terephthalate, polyethylene naphthalate. As previously explained, preferred are optically clear elastomers, e.g. silicone elastomers which are frequently based on polydimethylsiloxane.

The insert may be of metal or plastics having a higher melting point than that of the body, and conveniently may be of e.g. acetal, polypropylene, hard rubber, acrylonitrile-butadiene-styrene (ABS) or nylon. Instead of the use of adhesive labels 4, an image may if desired be printed directly onto the surfaces 2a, 2b using e.g. an ink jet printer and an ink that is adherent to the insert 2.

Shapes other than spherical may be used for the cap, e.g. a cylindrical shape, and the moulded-in insert may have a single image-carrying surface or it may have three or more image-carrying surfaces. The images may be graphics, alphanumeric or a combination of alphanumerics and graphics.

The writing instrument 3, whose dimensions are similar to the prior art pen may be a ball-pen, a roller-ball pen, a fibre-tipped pen, a felt-tipped pen, or a pencil. It may have a single ball top at one end or it may have a top at one end and a cap at the other, the shapes of the top and the cap being the same or different. Other possibilities include:
Single/double ball on the end of a stick
Single/double non ball shape on the end of a pen/stick for playing a game (closest to wall, in a target zone etc)
3D Character molded in ball/shape as well as or in addition to the use of a molded insert
Image on outside of ball/shape.

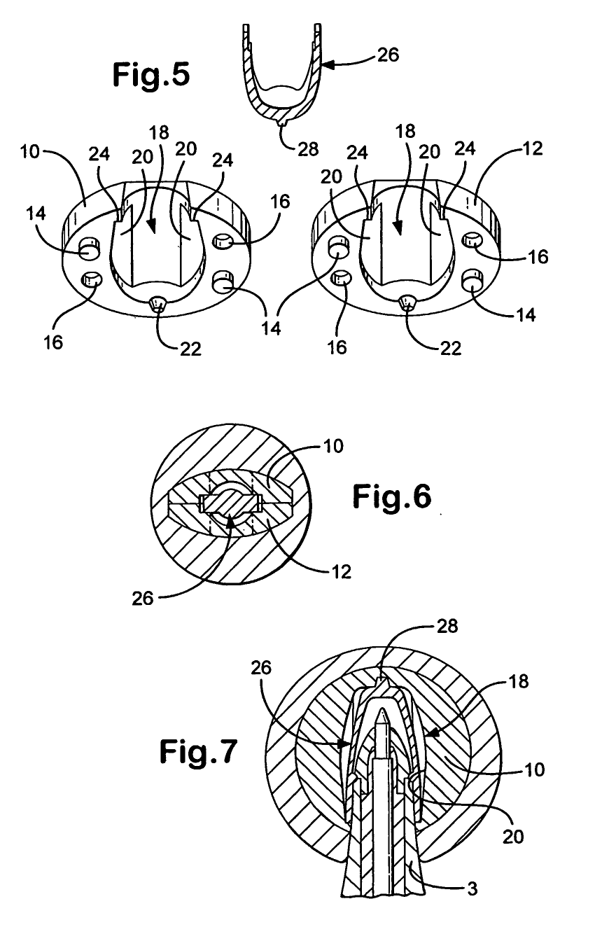

FIGS. 5-7 relate to a further embodiment wherein the insert for the top comprises first and second abutting portions for assembly prior to formation e.g. by molding of the body of transparent material. In some embodiments, the insert may comprise an insert body e.g. of polycarbonate or other relatively rigid material and clip means of nylon, ABS or other relatively resilient material snap located in the insert body after formation of the body of transparent material.

In FIG. 5 a two-part molded-in insert comprises first and second halves 10, 12 of polycarbonate or other suitable plastics material having planar abutting blind faces that locate together by means of pegs 14 that are received in sockets 16. Part cylindrical concave surfaces are provided on the blind faces of the insert halves 10,12 to define, when the insert is assembled, a pen-receiving cavity. The sides of the surfaces 18 are bounded by planar surfaces 20 that are generally parallel to but recessed below the abutting planar surfaces to define clip-receiving spaces. The blind ends of surfaces 18 lead to clip location half sockets 22. Clip-retaining faces 24 are formed at the outer ends of the surfaces 22.

Also shown in FIG. 5 is a bifurcated spring clip 26 of ABS, nylon or other suitable plastics material having at its intended inner end a locating stud 28. When the transparent silicone rubber has been molded around the assembled insert 10,12, the clip can be inserted through the open end of the cap into the cylindrical cavity, where its stud 28 locates in the socket defined at 22, and its arms fit between the surfaces 20 and snap locate behind the retaining faces 24.

To make a cap, the insert halves 10,12 are offered together after which the resulting cylindrical cavity defined by surfaces 18 receives a steel insert for supporting the insert halves during the molding process and reducing or preventing deformation. The clear silicone rubber is then molded around the insert halves to form the outer portion of the cap, after which the steel insert is withdrawn and the spring clip is inserted into place. The pen 3 can then be fitted into the cap as shown in FIG. 7.

1. A top for a writing instrument comprising a body of transparent material, an insert encapsulated within the body, and at least one display face defined by portions of the insert for displaying an image through the body to the exterior.

2. The top of claim 1, wherein the body comprises an elastomeric material.

3. The top of claim 2, wherein the body comprises a siloxane elastomer.

4. The top of claim 1, wherein the body is generally spherical.

5. The top of claim 1, wherein the insert comprises first and second abutting portions for assembly prior to formation of the body of transparent material.

6. The top of claim 1, wherein the insert comprises an insert body and clip means snap located in the insert body after formation of the body of transparent material.

7. The top of claim 1, wherein the display face carries a directly applied image.

8. The top of claim 1, wherein the display face carries a label having an image applied thereto.

9. The top of claim 1, wherein the body provides opposite first and second display faces.

10. The top of claim 9, wherein the display faces are convex when the insert is viewed in end profile.

11. A writing instrument or a stick having a top comprising a body of transparent material, an insert encapsulated within the body, and at least one display face defined by portions of the insert for displaying an image through the body to the exterior.

12. The writing instrument of claim 11, having at each end a top or cap comprising a body of transparent material, an insert encapsulated within the body, and at least one display face defined by portions of the insert for displaying an image through the body to the exterior.

13. A top for a writing instrument comprising a body of plastics material molded in the shape of a three-dimensional figure or molded in the shape of a ball and carrying an image on the outside of the ball.

14. The top of claim 13, wherein the figure is a character.

15. The top of claim 13, wherein the body comprises a silicone rubber or other elastomer.

16-18. (canceled)

19. The writing instrument of claim 11, wherein the body comprises an elastomeric material.

20. The writing instrument of claim 11, wherein the body comprises a siloxane elastomer.

21. The writing instrument of claim 11, wherein the body is generally spherical.

22. The writing instrument of claim 11, wherein the body of transparent material comprises a plastic material molded in the shape of a three-dimensional figure.

23. The writing instrument of claim 11, wherein the body of transparent material comprises a plastic material molded in the shape of a ball.
